(19) United States
(12) Patent Application Publication
(10) Pub. No.: US 2010/0055486 A1
(43) Pub. Date: Mar. 4, 2010

(54) Compacted, lock-stabilized scrap-metal bundle, lock-stabilization thereof, and associated bundling apparatus

(75) Inventor: David J. Miller, Portland, OR (US)

Correspondence Address: ROBERT D. VARITZ, P.C., 4915 SE 33RD PLACE, PORTLAND, OR, 97202, US

(73) Assignee: SSI Shredding Systems, Inc.

(21) Appl. No.: 12/583,971

(22) Filed: Aug. 29, 2009

Related U.S. Application Data
(60) Provisional application No. 61/190,802, filed on Sep. 2, 2008.

(51) Int. Cl. B30B 1/32; B30B 7/04; B30B 7/00

(52) U.S. Cl. 428/544; 100/42; 100/233

(57) ABSTRACT

Apparatus and methodology for compacting to a final, lock-stabilized bundle an initial charge of randomly and chaotically arrayed, loose pieces of scrap metal, and also a final, lock-stabilized bundle of such material, per se.

### BACKGROUND AND SUMMARY OF THE INVENTION

This invention relates to apparatus and methodology for compacting to a final, lock-stabilized bundle an initial charge of randomly and chaotically arrayed, loose pieces of scrap metal. It also relates to a final, lock-stabilized bundle of such material, per se.

The invention successfully addresses the instability difficulty often experienced with respect to a bundle of traditionally compacted scrap metal—a difficulty evidenced by loosening and shedding of pieces contained in the bundle.

According to the invention, a collection, called herein a charge, of loose scrap metal is suitably placed in an elongate compacting chamber in a compactor, wherein, initially, along the long axis of the chamber, the charge is first generally compacted traditionally, in a first compacting stroke, into a bundle, typically (though not necessarily) possessing a cubic shape which might have dimensions (used simply for illustration purposes herein) such as about 5-feet high, by about 7-feet wide, by about 8-feet long, or even larger. The compactor might be (though not necessarily) a trailered, wheel-borne device, wherein the compacting chamber has side and end walls, with one end wall (about 5×7 rectangular) acting as an openable closure for a bundle-discharge portal, and the other end wall (also about 5×7 rectangular) taking the form of a reversible, power-driven platen, which is power-drivable along the long axis of the chamber toward the first-mentioned end wall, as by an hydraulic pressure-fluid system, to effect overall, first-stage material compaction in the mentioned first compacting stroke.

Provided, generally centrally (on the long axis of the compacting chamber), in the second-mentioned, power-driven end wall, and moveable as a unit therewith, is a relatively and reversibly movable, secondary, compacting piston, also referred to herein as a power-driven nose-platen, which, for illustration purposes herein has non-critical dimensions of about 18-inches high, 36-inches wide, and 50-inches long, or deep (along the long axis of the compacting chamber) is independently power-drivable in a second compacting stroke to drive into the nominally, normally pre-compacted (first compacting stroke) bundle of scrap metal, thereby to create a unique, indented, high-compaction hollow, or indentation, which is characterized by a “surround” of greater material densification and compaction centrally within the otherwise normal-compaction (first stage) bundle of material. The indented hollow, in the illustration of the invention provided herein, is formed in one of the 5-foot by 7-foot sides of the first-stage compaction bundle, and might extend into that side by a central indentation depth of about 16-inches.

These representative, indentation dimensions, while not per se critical, have been found to work well with the above-mentioned, illustrative, 5×7 basic transverse dimensions of the compacting chamber.

What has been discovered with respect to this proposed apparatus, the just-outlined compacting practice, and the resulting side-indented bundle, is that the formation of the unique, indented, greater-surrounding-densification hollow effectively produces a locking together of substantially the entirety of the remainder of the “otherwise normally compacted” bundle of scrap-metal material, whereby no added, external banding, for example, is required to hold the overall compacted bundle intact.

There are various ways to express the apparatus of the present invention, one of which is to describe it as apparatus for power-compacting, to a dimensionally stabilized, self-locking, final-stage compaction bundle, a charge of initially loose scrap metal including (a) first compacting structure (a moveable wall and an associated power driver) operable in a first compacting stroke to produce a first-stage compaction bundle of such metal, with such a first-stage bundle having sides, and (b) second compacting structure (a moveable piston and an associated power driver) operatively associated with the first compacting structure, thereafter operable in a second compacting stroke to produce, from the first-stage bundle, the desired, final-stage compaction bundle, which bundle is defined, via the second compacting stroke, by an additional compaction indentation in a side of the first-stage bundle.

Another, more particular description may characterize the invention as apparatus for power-compacting, to a dimensionally stabilized, self-locking final-stage compaction bundle, a charge of loose scrap metal including (1) an elongate compacting chamber adapted to receive such a charge, and having (a) a long axis, (b) side-wall structure circumsurrounding that axis, and (c) a pair of spaced, relatively movable end walls defined with perimeters substantially closing, with relative-motion clearance, upon the side-wall structure around the long axis, with at least one of the end walls acting as a platen (part of the first compacting structure) which is advanceable reversibly under power toward the other end wall in a first compacting stroke, (2) a first power driver (also part of the first compacting structure) drivingly connected to the at least one end wall, actuatable in a first power stroke to implement the mentioned, first compacting stroke, thus to create a first-stage compaction bundle, (3) a piston (part of the second compacting structure) acting as a nose-platen which is advanceable reversibly under power in a second compacting stroke generally centrally along chamber's long axis in the manner of a moveable protrusion extending from, and spaced within the perimeter of, the mentioned, at least one end wall toward the other end wall, and (4) a second power driver (also part of the second compacting structure) drivingly connected to the piston, actuatable in a second power stroke to implement, subsequent to the mentioned first compacting stroke, a second compacting stroke, thus to create the desired, final-stage compaction bundle possessing a piston-produced, self-locking indentation in the portion of the first-stage bundle which faces the at least one end wall.

From one methodologic point of view, the invention may be expressed as a method for stabilizing an otherwise normally compacted bundle of scrap metal having sides with lateral dimensions including forming, by additional compaction and densification, an indented hollow extending generally centrally into, and within the lateral margins of, one side of that bundle.

Another way of viewing this methodology is as a method for creating a power-compacted, dimensionally stabilized, self-locking bundle from a charge of loose scrap metal including the steps of (a) applying a first compacting force to such a charge to create therefrom a first-stage compaction bundle having sides, and (b) thereafter, applying a second compacting force to the first-stage bundle to create a compaction indentation in a side of the first-stage bundle.

The result of implementing this methodology utilizing the outlined apparatus is a dimensionally stabilized, self-locking final-stage compaction bundle formed from a charge of initially loose scrap metal including (1) sides with lateral dimensions, and (2) an additional compaction, and densification-creating, indented hollow extending generally centrally into, and within the lateral margins of, one of those sides.

These and other objects, features and advantages of the invention will become more fully apparent as the detailed description thereof which now follows is read in conjunction with the accompanying drawings.

### DESCRIPTIONS OF THE DRAWINGS

FIG. 1 is a side elevation illustrating the apparatus of the invention deployed as a portable unit mounted on the bed, or frame, of a tractor-drawn trailer.

FIGS. 2-4, inclusive, are fragmentary, simplified, isolated, isometric views illustrating, specifically, the compactor (compactor apparatus) of the invention, and the implementations therein, according to the invention, of first and second compacting strokes which are employed in accordance with the methodology of the invention to produce what is referred to herein as a dimensionally stabilized, self-locking, final-stage compaction bundle of originally loose scrap metal—metal which has been introduced as a “charge” into the invention.

FIG. 5 is an isolated, isometric, idealized and simplified view of what is referred to herein as a final-stage compaction bundle prepared by the apparatus, and according to the methodology of, the present invention, including a clearly illustrated compaction indentation which has been formed in one side of the bundle in the above-referred-to second compacting stroke.

### DETAILED DESCRIPTION OF THE INVENTION

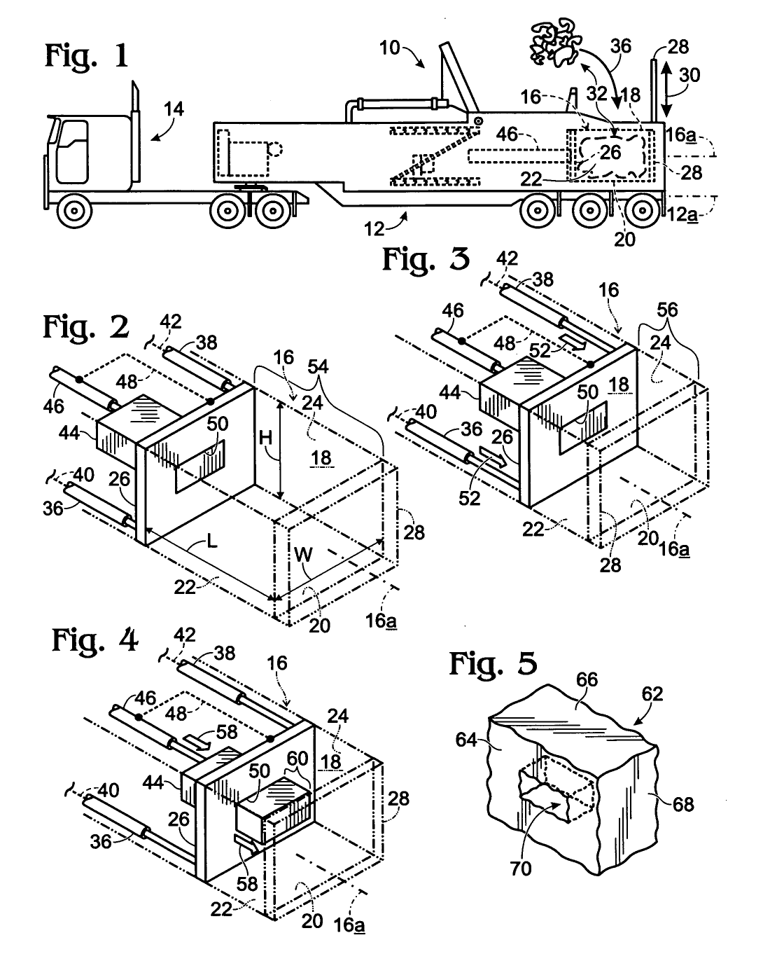

Turning now to the drawings, and referring first of all to FIG. 1, indicated generally at 10 is a scrap-metal compactor which is deployed, as illustrated in this figure, as a mobile unit, mounted for trailering on the frame, or bed, of an elongate trailer 12, the latter being shown coupled to a conventional tractor 14 for hauling to different use locations. Compactor 10 is also referred to herein as apparatus for power-compacting, to a dimensionally stabilized, self-locking, final-stage compaction bundle, a charge of initially chaotic and loose scrap metal.

It should be understood that while compactor 10 is illustrated herein in the form of a mobile unit mounted on a trailer, the compactor this invention may be deployed in a variety of different ways, including, for example, as a permanently placed installation at a site where regular scrap metal is accumulated and compacted for subsequent handling.

It should also be understood that all of the elements of compactor 10, as illustrated in the drawings herein, are pictured not necessarily with any attention to scale or to various specific details of construction, recognizing that the exact ways in which the compactor of the invention may be sized and particularly constructed can be, per se, conventional, and open to a variety of manners of implementation in accordance with a user's wishes. Accordingly, the basic features of the invention, which are fully illustrated, are shown and described herein in relatively simplified manners, but definitively in manners which completely explain to those skilled in the art how one may construct and practice the invention in settings and manners of their choices.

In general terms, therefore, apparatus, or compactor 10, includes an elongate compacting chamber 16 which, in the specific illustration of the invention presented herein, takes the form of a rectilinear structure (see particularly FIG. 2) having a vertical height H of about 5-feet, a lateral width W of about 7-feet, and a nominal, full, length L of about 8-feet. In a manner of speaking, chamber 16, with respect to its nominal length, extends generally with its own long axis 16a vertically spaced from and substantially paralleling the long axis 12a of trailer 12. It should be understood that, at a user's free choice, different rectilinear dimensions may be employed in and for chamber 16, and also that chamber rectilinearity may not be used at all, in the specific configuring of a compacting chamber in accordance with the basic features of the invention.

With attention directed to FIGS. 2-4, inclusive, along with FIG. 1, chamber 16 is formed with side-wall structure including upper and lower walls, 18, 20, respectively, and a pair of spaced the lateral walls 22, 24 (near and far, respectively, in the drawings). These upper, lower and lateral walls are illustrated variously, and in certain instances only fragmentarily, in both dashed, and dash-double-dot, lines in FIGS. 1-4, inclusive.

Compacting chamber 16 also includes a pair of spaced, relatively movable end walls 26, 28 located at the front and rear ends, respectively, of the chamber. In FIG. 1, end wall 28 is shown in two different, relatively vertically-shifted-to positions, one of which, a position closing the rear end (also referred to as bundle-discharge end, or portal) of the chamber, is illustrated in dashed lines, and the other of which, a position opening the chamber's rear end, is shown in solid lines raised relative to the other components in chamber 16. A double-headed arrow 30 illustrates reversible, vertical moveability of end wall 28 to close and open the bundle-discharge end of the chamber.

Appropriate, conventional power-driven mechanism (not specifically shown in the drawings) is provided operatively connected to end wall 28 for selectively raising and lowering this end wall between the two positions shown for it in FIG. 1. Also not specifically illustrated in the drawings is appropriate, conventional structure which is provided for opening and closing, and for suitably exposing near the top of the compactor, upper chamber wall 18 and the top of chamber 16, respectively, for the purpose of placing into chamber 16 an initial charge of loose scrap metal, such as the charge shown in two, moved locations at 32 in FIG. 1. The upper illustration of this charge, which appears above compactor 10 and immediately above a curved arrow 36, represents such a charge of metal which is about to be placed in chamber 16. The lower, “outline” illustration of charge 32 in FIG. 1 pictures this charge once it has been placed initially inside chamber 16 as a charge-fill for compacting. Those skilled in the art will understand that, after such a charge has been placed in the open top of chamber 16, upper wall 18 is returned to a condition, as is specifically pictured in FIGS. 1-4, inclusive, in the drawings, closing the top of the chamber.

Continuing now with a description of compactor 10, and specifically with regard to components within, and operatively associated with, chamber 16, forward end wall 26, which is also referred to herein as the “one” end wall, and also as a movable platen, is mounted for reversible, reciprocal movement forwardly and rearwardly within the side-wall structure in chamber 16, both to produce, as a part of a first compacting structure, what is referred to herein as a first compacting stroke to compact (initially) a charge of loose and chaotic scrap metal which has been loaded into chamber 16, and ultimately, to discharge a finally completed (final-stage) compacted bundle of material rearwardly and outwardly (via the rear, bundle-discharge portal) from the chamber, with rear end wall 28 lifted as illustrated in solid lines in FIG. 1 to open the bundle-discharge end of chamber 16. Wall 26 is sized so that its lateral margins effectively close, with appropriate motion clearance capability, upon side walls 18, 20, 22, 24.

Drivingly connected to end wall 26 for the purpose of moving this wall under power back and forth within the side-wall structure in chamber 16, is what is referred to herein as a first power driver which, herein, takes the form of a pair of pressure-fluid-actuated, elongate rams 36, 38 which are appropriately drivingly interposed wall 26 and other structure included in compactor 10, forwardly of chamber 16. The driving interconnection which exists in this interposition, as just described with this other structure within compactor 10, is illustrated only schematically, and in fragmentary dashed lines, at 40, 42 in FIGS. 2-4, for rams 36, 38, respectively. Rams 36, 38, along with wall 26, form the earlier-mentioned first compacting structure.

Appropriately mounted for motion, effectively as a unit with end wall 26, is what is referred to herein as a second compacting structure in the form of a rectilinear piston, or nose platen, 44, and an associated, second power driver which, herein, takes the form of an elongate, pressure-fluid-actuated ram 46. Ram 46 is drivingly interposed piston 44 and wall 26 via a drive interconnection, generally conventional in nature, which is represented schematically in FIGS. 2-4, inclusive, by a dashed line 48.

As can be seen particularly in FIGS. 2-4, inclusive, piston, or nose platen, 44 is mounted within the lateral margins of the side-wall structure in chamber 16 for power-driven, reciprocal, reversible motion, generally along chamber axis 16a, under the influence of ram 46, through a suitable, central, accommodating window complementarily furnished as a through-aperture 50 in end wall 26. Window 50 has a height herein of about 18-inches, and a width of about 36-inches to accommodate, substantially, the two, previously mentioned, similar height and width dimensions, i.e., the transverse lateral dimensions, of rectilinear piston 44. These window and lateral piston dimensions are, of course, appropriately, actually related to one another in such a fashion that motion clearance is afforded the piston within window 50. The long dimension of piston 44 herein is approximately 50-inches.

With actuation of ram 46 to produce, along with piston 44, what is referred to herein as the second compacting stroke, piston 44 moves through window 50 into the interior of chamber 16 as a protrusion (see particularly FIG. 4) by a distance typically of about 16-inches (though this is readily user variable). It is this second-compacting-stroke motion of piston 44, inwardly into chamber 16 relative to end wall 26 (when that end wall has finished the mentioned, first compacting stroke, and occupies the disposition within the interior of the sidewalls which form chamber 16 as pictured in FIGS. 3 and 4), which produces the desired and unique self-locking, so-called, piston-produced compaction indentation hollow (still to be discussed) in that portion of a bundle of scrap metal initially compacted within chamber 16. This indentation hollow has a shape which is generally related to the shape of that portion of piston 44 which extends as a protrusion (see especially FIG. 4) into the metal bundle on the side of end wall 26 which faces rearwardly into the chamber toward end wall 28.

A typical compacting action in accordance with practice of the present invention may be conducted, generally speaking, in the following manner. A selected charge of loose and initially chaotic scrap metal, such as that shown at 32 in the upper illustration of scrap metal in FIG. 1, is loaded, as indicated by arrow 36, into open-topped compacting chamber 16 until the chamber is appropriately filled in accordance with a user's wishes. The charge-filled condition of the chamber is as pictured in FIG. 1 for the lower illustration of charge 32.

The open top of chamber 16 is then closed by upper wall 18, and at this point in time, the loaded charge is ready for compacting.

Depending upon the charge fill which has been introduced into the chamber, and, of course, upon the specific nature of the scrap metal material which makes up that charge, the operator may make a selection regarding how much initial, or first, compacting force to use, or, perhaps, that operator has set a default compacting behavior which results in compaction, in the first to stage of compacting, occurring until a particular maximum compacting force (and stroke) has been achieved. In any event, such an initial compacting force, and the resulting first compacting stroke, are applied/initiated, with end wall 26 advancing under the influence of rams 36, 38 to a longitudinal position within the side-wall structure in chamber 16 such as that illustrated generally in FIG. 3. For illustration purposes herein, this initial compacting stroke, which is performed with piston 44 in the condition relative to wall 26 which is illustrated for it in FIGS. 2 and 3, with its “near”, planar face in these figures substantially flush and coextensive with the “near”, planar face of wall 26, is one whereby the longitudinal dimension of the initially compacted (first-stage compaction) bundle of scrap material might, as measured along axis 16a, be about 3- or 4-feet. This initial compacting stroke which is illustrated by arrows 52 in FIG. 3, “length-compacts” the scrap-metal charge from an initial, un-compacted length illustrated by the bracket shown at 54 in FIG. 2 to a final, compacted length which is illustrated by a bracket 56 seen in FIG. 3.

On completion of the first, or initial, compacting stroke just described, and with end wall 26 held at the location illustrated for it in FIG. 3, piston 44 and ram 46 are actuated with a second compacting force to perform the mentioned, second compacting stroke—an event during which piston 44 is driven inwardly and centrally into the initially compacted scrap-metal bundle to create the earlier mentioned compaction and densification-creating indentation hollow which essentially is defined with an outline generally, but roughly, following the shape of that portion of piston 44 which extends as a protrusion from end wall 26 into the compacting chamber. This second compacting stroke is illustrated in FIG. 4 by a pair of arrows 58, and the length of the protrusion/extension of piston 44 into the chamber is illustrated in this same figure by a bracket 60.

Once again, with respect to how compacting takes place with regarding applied compacting forces and pressures, the operator makes a choice, depending upon “initial” compaction-bundle circumstances, or perhaps pre-makes a choice with preselected default “settings”, just how far to drive the protruding portion of piston 44 into the first-stage compaction bundle. For example, a typical choice might be, with respect to an initially produced compaction bundle having a “chamber axial length” of about 36-inches, for piston 44 to be driven a distance of about 16-inches into that side of the pre-compacted (first-stage compaction) bundle which faces end wall 26.

More formal and somewhat more elaborated descriptions of the compacting methodology of the present invention have been presented hereinabove, and reference here is made back to those methodologic descriptions for a further understanding regarding how practice of the invention unfolds during an overall scrap-metal compacting operation.

Turning attention now to FIG. 5 in the drawings, here, indicated generally at 62 in outline form is what is referred to as a final-stage compaction bundle of the charge of scrap metal illustrated at 32 in FIG. 1. This final-stage bundle has sides, such as sides 64, 66, 68 with obvious lateral dimensions determined by the geometry of compacting chamber 16, and includes, substantially centrally in side 64, the uniquely piston-produced compaction and densification-creating indentation hollow, shown generally at 70 in this figure, as proposed by the present invention.

With regard to the final-stage bundle appearance which is presented in FIG. 5, one should note that the bundle outline here pictured is somewhat idealized in terms of its configuration, particularly with regard to the appearance of indentation 70. Also to note is that, prior to the creation of indentation 70 in the second compacting stroke, the just-then-before-existing, initially compacted (first-stage) bundle of scrap metal has much the appearance of the larger form which is pictured as an outline in FIG. 5. This first-compaction-stage bundle form is referred to herein as a first-stage compaction bundle, and also as an otherwise normally compacted bundle.

In the regions immediately surrounding the inside boundaries of indentation hollow 70, there is a considerable compaction densification of scrap-metal material. Surprisingly, the preparation of such an indentation hollow through second-stage compaction as described herein, and in accordance with practice of the present invention, produces the desired, final-stage compaction bundle which is uniquely self locking to possess the anti-shedding stability characteristics mentioned earlier herein.

Accordingly, while preferred and best-mode embodiments of the invention apparatus, of the completed compaction bundle produced by that apparatus, and of the implemented invention methodology, have been illustrated and described herein, with certain modifications and variations suggested, it should be understood that other variations and modifications may be made without departing from the spirit of the invention. All of such other modifications and variations are intended to be considered to be within the scope of the claims to invention herein.

I claim:

1. Apparatus for power-compacting, to a dimensionally stabilized, self-locking, final-stage compaction bundle, a charge of initially loose scrap metal comprising
first compacting structure operable in a first compacting stroke to produce a first-stage compaction bundle of such metal, with such a first-stage bundle having sides, and
second compacting structure operatively associated with said first compacting structure, thereafter operable in a second compacting stroke to produce, from the first-stage bundle, the desired, final-stage compaction bundle which is defined, via the second compacting stroke, by an additional compaction and densification-creating indentation in a side of the first-stage bundle.

2. Apparatus for power-compacting to a dimensionally stabilized, self-locking final-stage compaction bundle, a charge of loose scrap metal comprising
an elongate compacting chamber adapted to receive such a charge, and having (a) a long axis, (b) side-wall structure circumsurrounding said axis, and (c) a pair of spaced, relatively movable end walls defined with perimeters substantially closing, with relative-motion clearance, upon said side-wall structure around said axis, with at least one of said end walls acting as a platen which is advanceable reversibly under power toward the other end wall in a first compacting stroke,
a first power driver drivingly connected to said at least one end wall, actuatable in a first power stroke to implement the mentioned, first compacting stroke, thus to create a first-stage compaction bundle,
a piston acting as a nose-platen which is advanceable reversibly under power in a second compacting stroke generally centrally along said axis in the manner of a moveable protrusion extending from, and spaced within the perimeter of, said at least one end wall toward the other end wall, and
a second power driver drivingly connected to said piston, actuatable in a second power stroke to implement, subsequent to the mentioned first compacting stroke, a second compacting stroke, thus to create the desired, final-stage compaction bundle possessing a piston-produced, self-locking indentation in the portion of the first-stage bundle which faces said at least one end wall.

3. A method for stabilizing an otherwise normally compacted bundle of scrap metal having sides with lateral dimensions comprising forming, by additional compaction and densification, an indented hollow extending generally centrally into, and within the lateral margins of, one side of that bundle.

4. A method for creating a power-compacted, dimensionally stabilized, self-locking bundle from a charge of loose scrap metal comprising
applying a first compacting force to such a charge to create therefrom a first-stage compaction bundle having sides, and
thereafter, applying a second compacting force to the first-stage bundle to create a compaction indentation in a side of the first-stage bundle.

5. A dimensionally stabilized, self-locking final-stage compaction bundle formed from a charge of initially loose scrap metal comprising
sides with lateral dimensions, and
an additional compaction, and densification-creating, indented hollow extending generally centrally into, and within the lateral margins of, one of said sides.
